(19) United States
(12) Patent Application Publication
(10) Pub. No.: US 2004/0161955 A1
(43) Pub. Date: Aug. 19, 2004

(54) Connecting device for connecting printed circuits and power cables connected to an electric apparatus

(75) Inventor: Andrea Cadamuro, Brescello (IT)

Correspondence Address: Shlesinger, Fitzsimmons & Shlesinger, Suite 1323, 183 East Main Street, Rochester, NY, 14604, US

(73) Assignee: Zapi S.P.A.

(21) Appl. No.: 10/778,378

(22) Filed: Feb. 12, 2004

(30) Foreign Application Priority Data
Feb. 17, 2003 (IT) PR2003A000010

(51) Int. Cl. H01R 4/66

(52) U.S. Cl. 439/95

(57) ABSTRACT

The invention deals with the field of connecting devices for connecting between printed circuits and power cables connected to an electric apparatus. The device provides for an electrically conducting metal cage (4) composed of a disk (4a) from which pins (4b) fall that are inserted into holes obtained in the printed circuits to be coupled with the printed circuits themselves.

The cage is equipped with a hole for passing a screw (6) stem.

### DESCRIPTION

Object of the present invention is a connecting device for connecting printed circuits and power cables connected to an electric apparatus.

Function of the device is distributing electric current to power devices inside and/or outside an electric apparatus.

Connecting devices, technically also defined as electromechanical joints, are already known; briefly, they are a normal screw with nut that is passed into a circular hole obtained in the printed circuit, and then is tightened with nut or equivalent.

With the known connecting devices, several inconveniences occurred that can bring about the breakage of the device itself and impair the correct passage of a current.

The inconveniences can be of a nature that is intrinsic to the device function or are due to external causes during its operation or installation.

Inconveniences of the intrinsic nature are due to the fact that the printed circuit is substantially composed of one or more thin plane copper plates in which currents flow that must pass through an output terminal.

In the output terminal, composed of a pin, currents are concentrated that come from one or more thin layers of copper; briefly, there is a connection of circuits from completely different physical realities, namely the connection of a thin plane plate, in which currents coming from different directions flow, and a pin or output terminal that collects and conveys all the above currents substantially in a single point.

Inconveniences of the extrinsic nature are due to temperature variations, vibration and impacts of the machine in which the power circuit is installed, forces exerted by power cables, tightening forces exerted when assembling; all inconveniences that, in the current system, reduce or impair a correct current passage from thin plane plate to output terminal.

In particular, when the joint loosens, an electric contacting leakage occurs and generates an increase in the passing electric resistance and consequently a temperature increase in the various parts in contact in the passage area between thin plane plate(s) and output terminal.

All this starts a series of alternate thermal cycles, ambient temperature (when the apparatus is off)—higher temperature (under apparatus working conditions), that tend to damage the weak joint element.

When the apparatus is subjected to thermal rushes, the junction system, between thin plane copper plate and output terminal, degenerates.

Owing to compression and relaxation tensions due to thermal variations, the junction system characteristics are subjected to a permanent mutation.

An irreversible and degenerative process starts that in relatively short times causes the electric connection destruction.

Object of the present invention is creating different conveying points of the printed circuit currents (thin plane copper plate or plates) toward a single direction and in a single point composed of the output terminal.

A further object of the present invention is avoiding the above-described inconveniences and in particular avoiding tension relaxation and connecting device loosening.

A further object of the present invention is increasing connection reliability by inserting an element that avoids time degeneration of the connection point between plate or plates and terminal.

These and other objects are all obtained by the connecting device for connecting printed circuits and power cables connected to an electric apparatus, object of the present invention, that is characterised as provided by the below-mentioned claims and in particular in that it comprises a electrically conductive metal cage that is substantially composed of a disk from which pins depart that are adapted to be inserted in holes obtained in the printed circuits in order to be coupled with the printed circuits themselves, said cage being adapted to house all or part of a tightening screw head, the disk, possibly also curved, of said cage being provided with an hole for passing the stem of said screw.

These and other features will be better pointed out by the following description of a preferred embodiment shown, merely as a non-limiting example, in the attached table of drawing in which:

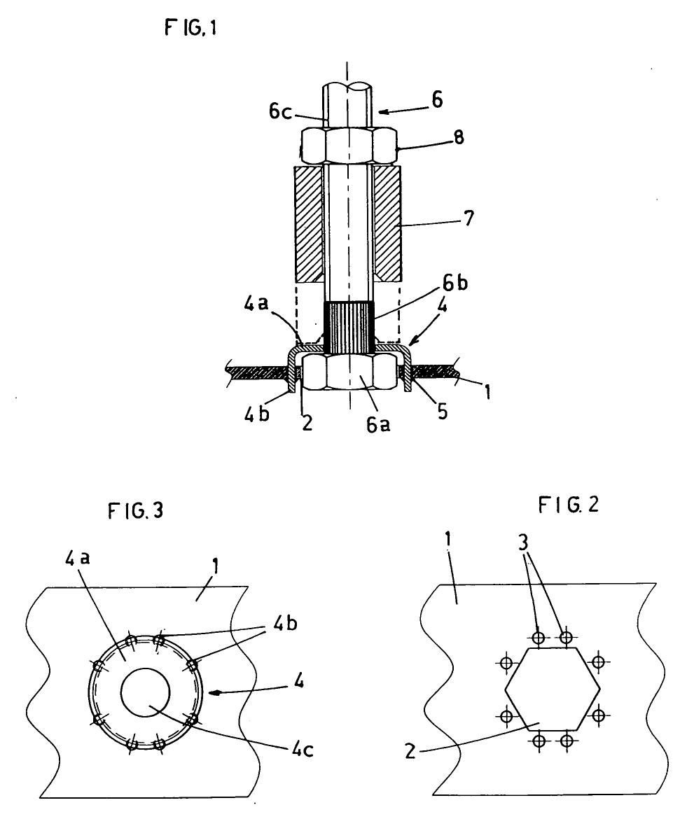

FIG. 1 shows the connecting device in elevation and inserted into a printed circuit;

FIG. 2 shows in a plan view the printed circuit next to the device application;

FIG. 3 shows in a top plane view the device applied to the printed circuit.

With reference to the figures, a printed circuit 1 is shown that has a polygonal or eccentric (in the shows example hexagonal) drilling 2.

Said hexagonal drilling is surrounded by a plurality of possibly metal holes 3 connected to one or more thin copper plates placed on the printed circuit.

Reference 4 shows an electrically conductive metal cage, for example made of copper, that is composed of a disk 4a from which pins 4b depart that are adapted to be inserted into the holes 3 in order to be coupled with the printed circuit, for example through welding 5.

A through hole 4c is obtained on the disk 4a and through it a locking screw 6 is inserted, equipped with a (hexagonal in the shown example) head 6a that is inserted inside the cage, abutting therewith, and inside the hexagonal drilling 2 of the printed circuit.

The screw 6 is equipped with a knurled or rolled area 6b placed between hexagonal head 6a and screw threading 6c.

Reference 7 shows a spacer made of a preferably electrically conductive material, such as aluminium or copper, that is coupled with the screw 6 by pressure-inserting it in the knurled or rolled area 6b.

In the drawing, the spacer is shown placed at a certain distance from the cage upon inserting; the dashed line shows the spacer in its locking position.

The lower spacer plane is abutting against the upper plane of the copper cage.

In the example shown, the spacer locking has been realised through an interference system, also helped by a possible nut 8 placed in the upper part of the screw 6, but it can also be realised with other mechanical means, such as for example through locking with a pin or other systems adapted to avoid axial screw movements with respect to the printed circuit. In the upper part of the screw 6, there is a nut 8 or equivalent system that, when suitably tightened, will finally and securely press the spacer 7 onto the disk 4a in order to guarantee reliability to the electric connection.

In some part of the upper area of the screw 6, the electric and/or mechanical connection can continue anywhere to transport electric current.

With the above-described device, the following advantages are obtained:

the cage has the advantage of concentrating many currents coming from one or more thin plane copper surfaces in a single output point;

the cage replaces a printed circuit as mechanical-electric connecting element and is an electrically conductive element whose mechanical properties are substantially unchanged when temperature changes in time;

it is impossible that the screw rotates onto itself since its head is inserted in a corresponding hole obtained in the card whose section is equal to the head section; screw anti-rotation could be exerted also by the cage itself;

it is impossible that the screw is withdrawn or axially moves with respect to the card since the spacer 7 is pressure-inserted in the rolled or knurled area till it abuts against the cage.

Obviously the cage, that in the example shown, has a cylindrical shape, can also have a different shape, such as for example the shape of a prism with polygonal base.

1. Connecting device for connecting printed circuits and power cables connected to an electric apparatus, characterised in that it comprises a electrically conductive metal cage (4) that is substantially composed of a disk (4a) from which pins (4b) depart that are adapted to be inserted in holes (3) obtained in the printed circuit(s) in order to be coupled with the printed circuit(s), said cage being adapted to house all or part of a screw head (6), the disk of said cage being provided with an hole (4c) for passing the screw (6) stem.

2. Device according to claim 1, characterised in that it comprises a locking screw (6) with polygonal or eccentric head that is adapted to be inserted into a corresponding drilling obtained in the printed circuit in order to prevent the screw rotation.

3. Device according to the previous claims, characterised in that it comprises a locking screw equipped with a locking area and a spacer (7) made of electrically conductive material or that is not adapted to be securely coupled with the screw (6) to avoid axial movements of the screw with respect to the card.

4. Device according to the previous claims, characterised in that it comprises a mechanical locking system for coupling the spacer (7) with the screw (6).

5. Device according to claim 4, characterised in that the screw is provided with an interference locking area of the coupling surface of the spacer with the screw itself.

6. Device according to claim 5, characterised in that the screw (6) is provided with a rolled or knurled area (6b) for its interference coupling with the spacer.
